(19) United States
(12) Patent Application Publication
(10) Pub. No.: US 2017/0057134 A1
(43) Pub. Date: Mar. 2, 2017

(54) METHOD FOR MANUFACTURING AN OPTICAL ELEMENT

(71) Applicant: ProRadiant Opto. Co., Ltd., Taoyuang City (TW)

(72) Inventors: GWO-JUH TZENG, Taoyuang City (TW); CHUN-PIN CHANG, Taoyuang City (TW)

(21) Appl. No.: 14/841,821

(22) Filed: Sep. 1, 2015

(51) Int. Cl. B29C 45/00; F21V 3/04

(52) U.S. Cl. CPC B29C 45/0055; F21V 3/049; B29L 2011/0016

(57) ABSTRACT

In a method for manufacturing an optical element disclosed by the present invention, at least one atomized surface forming member corresponding to an atomized surface of the optical element is provided in an injection mold for molding the optical element. Through loading surface 3D parameters of the atomized surface forming member as well as laser pattern processing parameters, the method forms a rough surface having uniform roughness at a non-planar part of at least one curved or arched plane. Thus, an atomized surface may be disposed at a non-planar part of a curved or arched plane of the optical element, and a uniform atomization level may be achieved at the entire atomized surface. The method allows the optical element to produce preferred optical performance and effects, facilitates reducing material costs of the optical element, and promotes maintaining the expected mechanical structural strength of the optical element.

### BACKGROUND OF THE INVENTION

a) Field of the Invention

The invention relates in general to a technology for processing an optical element, and more particular to a method for manufacturing an optical element having an atomized surface as well as enhanced optical performance and effects.

b) Description of the Prior Art

As generally known, light emitting diodes (LEDs) feature low power consumption, a long component life cycle, no light warming period, a fast response speed, a small volume, vibration resistance, suitability for mass production, and high feasibility for applications of extremely small or array elements. Therefore, LEDs are extensively applied as indicator lamps and display devices of information, communication and consumer electronic products. Further, LEDs even gradually replace incandescent bulbs or fluorescent tubes to become a preferred choice as a new-generation light source.

Nonetheless, when applying an LED for a lighting purpose, a substantial number of light emitting chips are required to operate simultaneously to achieve the brightness performance of conventional incandescent bulbs or fluorescent tubes. Although the brightness and heat dissipation capability of LEDs have been significantly increased, LEDs, in size of small peas, still suffer from shortcomings of excessively focused brightness towards a center, non-directional scattering of light intensity towards all directions, and the incapability of illuminating an illumination target in the front by an illumination beam in a controlled range.

Thus, in order to illuminate a target with sufficient light intensity and light range, a poly light or an optical element is used to control the light intensity and to emit in an appropriate range towards the front. For example, a surface of a lamp shade or an optical element is processed to appear as a lattice or a beehive or processed by atomization, such that the light path of a corresponding LED can be distributed to further enhance the uniformity of light.

In the prior art, in a conventional manufacturing method of an atomized surface of an optical element, in addition to etching with a chemical solution for causing a rough surface in an injected mold of the optical element, a rough surface can also be formed through pre-processing an injection mold of the optical element by laser. Thus, an atomized surface corresponding to the rough surface of the mold can be formed at a surface of the optical element formed through the mold. According to horizontal lateral and longitudinal as well vertical processing parameters of a laser apparatus established, a mold plate in form of a plane or a planar region of the mold is processed to generate a predetermined laser pattern.

In contrast, by directly processing with a chemical solution, not only a yield rate is low, but also exact replication may be difficult to achieve. Further, with a gradual process on a planar mold plate or a planar region of a mold according to horizontal lateral and longitudinal as well as vertical processing parameters of a laser apparatus established, an optical element formed through such molding formation can only be presented in a structure of an optical plate (or a light guiding plate), or an atomized surface 11 can be constructed only at a planar part of the optical element 10, as shown in FIG. 1. Further, an atomized surface originally presented in a curved or arched plane needs to be modified to a flat plane to adapt to the laser process. As a result, expected optical performance and effects of the optical element may not be obtained, material costs of the optical element may be increased, or the mechanical structural strength of the optical element may be deteriorated.

### SUMMARY OF THE INVENTION

In view of the above, it is an object of the present invention to provide a method for manufacturing an optical element having an atomized surface to achieve preferred optical performance and effects using the manufactured optical element.

To achieve the above object, the method for manufacturing an optical element of the present invention is applied to manufacture an optical element having at least one atomized surface. The method for manufacturing an optical element includes following steps. In step a, an injection mold for molding the optical element is provided. The injection mold is provided with at least one atomized surface forming member corresponding to the atomized surface of the optical element. In step b, surface three-dimensional (3D) parameters of the at least one atomized surface forming member are loaded into a 3D laser processing equipment, and the at least one atomized surface forming member is fixed onto a processing station of the 3D laser processing equipment. In step c, laser pattern processing parameters corresponding to the atomized surface of the optical element are established at the 3D laser processing equipment. In step d, the 3D laser processing equipment is activated, and the 3D laser processing equipment processes a surface of the at least one atomized surface forming member according to the loaded surface 3D parameters and laser pattern processing parameters to form a rough surface corresponding to a structure of the atomized surface of the optical element. In step e, the injection mold with all of the atomized surface forming members processed by the rough surface processing is installed to an injection molding equipment. In step f, the injection molding equipment is activated according to a configured operation mode of the injection molding equipment, an injection molding material is filled into the injection mold, and the optical element having at least one atomized surface is manufactured and obtained after the injection molding material has hardened and set.

More specifically, through loading surface 3D parameters of an atomized surface forming member as well as laser pattern processing parameters, the method for manufacturing an optical element of the present invention forms a rough surface having uniform roughness at a non-planar part of at least one curved or arched plane. Thus, according to application requirements of the optical element, an atomized surface may be disposed at a non-planar part of a curved or arched plane of the optical element, and a uniform atomization level may be achieved at the entire atomized surface. Therefore, the present invention allows the optical element to produce preferred optical performance and effects, facilitates reducing material costs of the optical element, and promotes maintaining the expected mechanical structural strength of the optical element.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a section view of a structure of a conventional optical element;

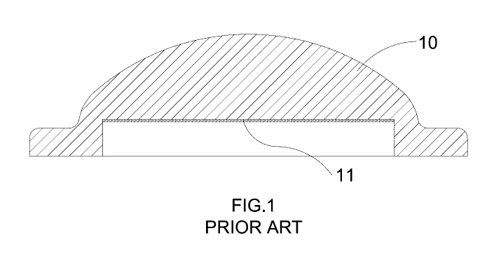

FIG. 2 is a schematic diagram of steps of a method for manufacturing an optical element of the present invention;

FIG. 3 is a section view of a structure of an optical element according to an embodiment of the present invention;

FIG. 4 is a section view of a structure of an injection mold of the present invention;

FIG. 5 is a schematic diagram of laser processing of an atomized surface forming member of the present invention;

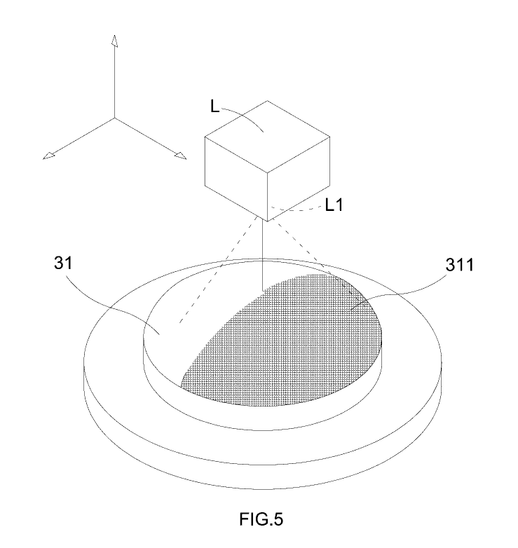

FIG. 6 is a schematic diagram of a status of injection molding of an optical element of the present invention; and

FIG. 7 is a schematic diagram of a status after injection molding of an optical element of the present invention.

### DETAILED DESCRIPTION OF THE PREFERRED EMBODIMENTS

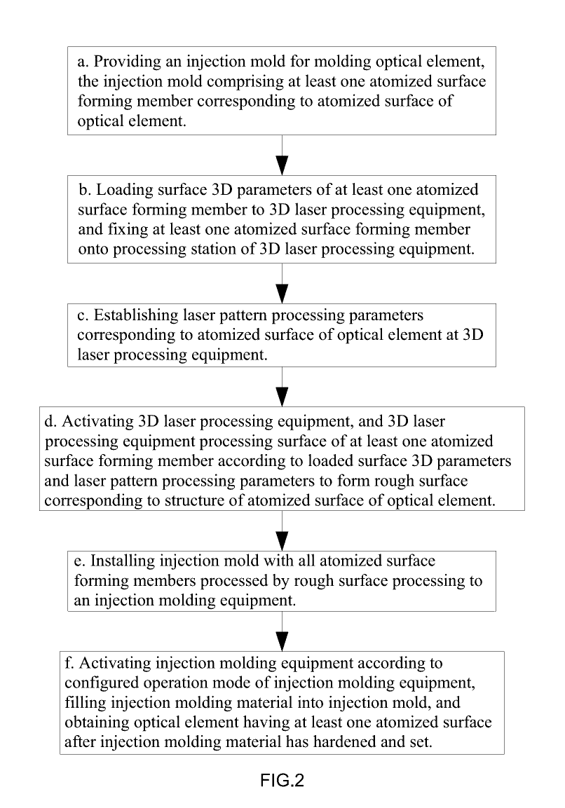

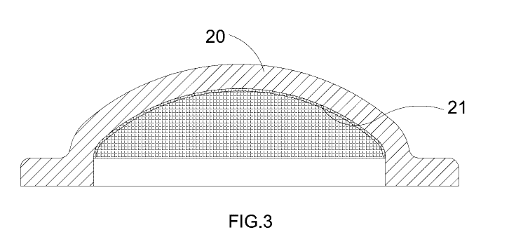

The present invention provides a method for manufacturing an optical element 20 having an atomized surface 21, as shown in FIG. 2 and FIG. 3. The method, capable of allowing the optical element 20 to produce preferred optical performance and effects, includes following steps.

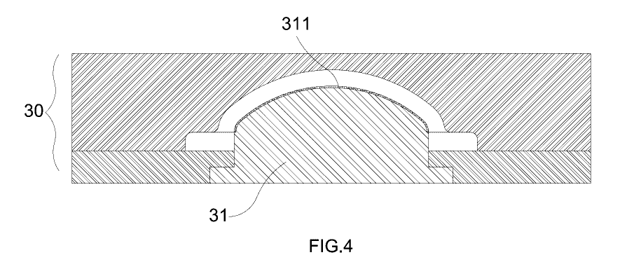

In step a, an injection mold 30 for molding the optical element 20 as shown in FIG. 4 is provided. The injection mold 30 is provided with at least one atomized surface forming member 31 corresponding to the atomized surface 21 of the optical element 20. In implementation, the at least one atomized surface forming member 31 may be configured as a mold core in the injection mold 30 or may be configured as a child of the injection mold 30.

In step b, surface three-dimensional (3D) parameters of the at least one atomized surface forming member 31 are loaded to a 3D laser processing equipment, and the at least one atomized surface forming member 31 is fixed onto a processing station of the 3D laser processing equipment. In implementation, the at least one atomized surface forming member 31 may be processed and formed by an automatic numerically controlled processing equipment, and the surface 3D parameters may be selected from processing parameters of the atomized surface forming member at the automatic numerically controlled processing equipment. Alternatively, the surface 3D parameters of the at least one atomized surface forming member may also be obtained through laser 3D scanning.

In step c, laser pattern processing parameters corresponding to the atomized surface of the optical element are established at the 3D laser processing equipment. In implementation, a plurality of laser pattern processing parameters having different formats are loaded into a database in advance for a user to select from. Alternatively, appropriate laser pattern processing parameters may be selected according to the surface 3D parameters of the atomized surface forming member 31 by the system.

In step d, the 3D laser processing equipment is activated, and the 3D laser processing equipment processes a surface of the at least one atomized surface forming member 31 according to the loaded surface 3D parameters and laser pattern processing parameters to form a rough surface 311 corresponding to the structure of the atomized surface of the optical element. More specifically, the laser processing equipment drives a plurality of reflecting mirrors L1 of a laser apparatus L to perform horizontal lateral, horizontal longitudinal and vertical processes according to the loaded surface 3D parameters. Thus, the rough surface 311 having uniform roughness is formed on a non-planar part of at least one curved or arched plane of the atomized surface forming member 31. For example but not limited to, the reflecting mirrors L1 are preferably freely rotatable reflecting mirrors.

In step e, the injection mold with all atomized surface forming members processed by the roughening surface processing is installed to an injection molding equipment. In implementation, the injection molding equipment may simultaneously mold a plurality of optical elements having the same structure.

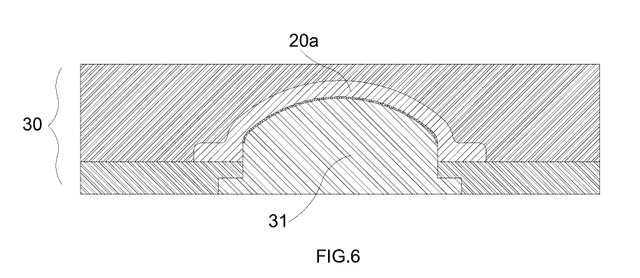

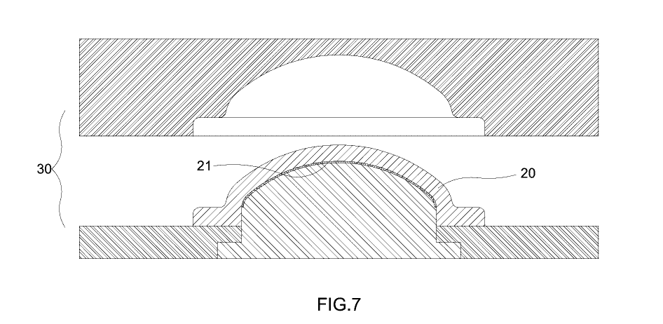

In step f, the injection molding equipment is activated according to a configured operation mode of the injection molding equipment. As shown in FIG. 6, an injection molding material 20a is filled into the injection mold 30. After the injection molding material 20a has hardened and set, the optical element 20 having at least one atomized surface 21 is manufactured and formed, as shown in FIG. 7.

In principle, according to application requirements of an optical element, the method for manufacturing an optical element of the present invention is capable of forming the atomized surface 21 at a non-planar part of a curved or arched plane of the optical element 20, and allowing the entire atomized surface 21 to achieve a uniform atomization level. Thus, the present invention allows the optical element 20 to produce preferred optical performance and effects, facilitates reducing material costs of the optical element 20, and promotes maintaining the expected mechanical structural strength of the optical element 20.

Further, in the method for manufacturing an optical element of the present invention, after the injection molding material has hardened and set, detections for a divergence angle and total energy of light of the manufactured optical element can be performed using a distribution curve instrument and integration machine to provide reference for whether to correct previous processing parameters.

Compared to the conventional solution, through loading surface 3D parameters of an atomized surface forming member as well as laser pattern processing parameters, the method for manufacturing an optical element of the present invention forms a rough surface having uniform roughness at a non-planar part of at least one curved or arched plane. Thus, according to application requirements of the optical element, an atomized surface may be disposed at a non-planar part of a curved or arched plane of the optical element, and a uniform roughness level may be achieved at the entire atomized surface. Therefore, the present invention allows the optical element to produce preferred optical performance and effects, facilitates reducing material costs of the optical element, and promotes maintaining the expected mechanical structural strength of the optical element.

In conclusion, the present invention provides a preferred and feasible method for manufacturing an optical method as disclosed. While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for manufacturing an optical element, for manufacturing an optical element having at least one atomized surface, the method comprising steps of:
a) providing an injection mold for molding the optical element, the injection mold comprising at least one atomized surface forming member corresponding to the atomized surface of the optical element;
b) loading three-dimensional (3D) parameters of the at least one atomized surface forming member into a 3D laser processing equipment, and fixing the at least one atomized surface forming member onto a processing station of the 3D laser processing equipment;
c) establishing laser pattern processing parameters corresponding to the atomized surface of the optical element at the 3D laser processing equipment;
d) activating the 3D laser processing equipment, and the 3D laser processing equipment processing a surface of the at least one atomized surface forming member according to the loaded surface 3D parameters and laser pattern processing parameters to form a rough surface corresponding to a structure of the atomized surface of the optical element;
e) installing the injection mold with all of the atomized surface forming members processed by the rough surface processing to an injection molding equipment; and
f) activating the injection molding equipment according to a configured operation mode of the injection molding equipment, filling an injection molding material into the injection mold, and obtaining the optical element having at least one atomized surface after the injection molding material has hardened and set.

2. The method for manufacturing an optical element according to claim 1, further comprising:
performing detections for a divergence angle and total energy of light of the manufactured optical element using a distribution curve instrument and integration machine to provide reference for whether to correct previous processing parameters.

3. The method for manufacturing an optical element according to claim 1, wherein the at least one atomized surface forming member is a mold core provided in the injection mold.

4. The method for manufacturing an optical element according to claim 1, wherein the at least one atomized surface forming member is a child provided in the injection mold.

5. The method for manufacturing an optical element according to claim 1, wherein the at least one atomized surface forming member is processed and formed by an automatic numerically controlled processing equipment, and the surface 3D parameters are selected from processing parameters of the atomized surface forming member at the automatic numerically controlled processing equipment.

6. The method for manufacturing an optical element according to claim 1, wherein the surface 3D parameters of the at least one atomized surface forming member are obtained by laser 3D scanning.

7. The method for manufacturing an optical element according to claim 1, wherein the 3D laser processing equipment is provided with a laser apparatus, and the laser apparatus comprises a plurality of reflecting mirrors.

8. The method for manufacturing an optical element according to claim 7, wherein the reflecting mirrors are freely rotatable.
